(19) United States
(12) Patent Application Publication
(10) Pub. No.: US 2026/0307240 A1
(43) Pub. Date: Oct. 8, 2026

(54) Drive Device for a Joint of a Robot Arm, Associated Robot Arm, and Corresponding Rotary Feedthrough

(71) Applicant: KUKA Deutschland GmbH, Augsburg (DE)

(72) Inventor: Andre Reekers, Augsburg (DE)

(73) Assignee: KUKA Deutschland GmbH, Augsburg (DE)

(21) Appl. No.: 19/569,713

(22) Filed: Mar. 17, 2026

(30) Foreign Application Priority Data
Mar. 25, 2025 (DE) 102025111500

(51) Int. Cl. B25J 9/10; B25J 19/00; H02K 7/116; H02K 11/33

(52) U.S. Cl. CPC B25J 9/102; B25J 19/0029; H02K 7/116; H02K 11/33

(57) ABSTRACT

A drive device for a robot arm joint includes a driver with a hub portion connected to an end portion of a cable guide tube, a radially outwardly offset cable guide portion, and a connecting portion connecting the hub portion to the cable guide portion. An annular space, arranged coaxially with a motor, is configured to accommodate a cable loop inserted therein. The cable guide portion is designed, when a cable is axially guided through the cable guide tube from the gearing-side tube end to the motor-side tube end and radially to the cable guide portion, to entrain the cable into the opening of the annular space when a gearing output element of the drive device is rotated, such that the cable is guided into the annular space at a circumferential point corresponding to the current rotational position of the gearing output element.

### CROSS-REFERENCE TO RELATED APPLICATIONS

This application claims the benefit of priority under 35 U.S.C. § 119(a) to German Patent Application No. 10 2025 111 500.1, filed Mar. 25, 2024, the disclosure of which is incorporated by reference herein in its entirety.

### Technical Field

The invention relates to a drive device for a joint of a robot arm, having a motor with a motor housing and a hollow motor shaft rotatably mounted in the motor housing, a gearing, arranged coaxially with the motor shaft, having a hollow gearing input element coupled to the motor shaft, a hollow gearing output element, and a support element coupling the gearing input element to the gearing output element, and a cable guide tube, connected to the gearing output element, which extends axially from its gearing-side tube end from the gearing output element through the hollow motor shaft to its motor-side tube end of the motor housing axially opposite the gearing, and forms a guide tube end portion there. The invention also relates to an associated robot arm and to a corresponding rotary feedthrough.

### BACKGROUND

CN 10 77 18 036 A describes a hollow, integrated, double-feedback gearing comprising a frameless motor, a brake, an incremental encoder, an absolute encoder, a high-speed motor shaft, a low-speed hollow shaft, an output flange, a motor shaft bearing and a hollow shaft bearing, a drive, a housing, a first bearing stand, a second bearing stand, a third bearing stand, as well as a connecting cable and a transition shaft, wherein a motor rotor, the incremental encoder, and the brake are installed on the high-speed motor shaft, and the absolute encoder is installed on the low-speed hollow shaft. Due to the double feedback at the compact high-precision hollow joint, the control accuracy is high, wherein the joints are hollow to allow for wiring.

### SUMMARY

An object of the invention is to create a drive device with a hollow motor shaft and a hollow gearing output element, in which a cable to be guided through the hollow motor shaft and the hollow gearing output element can be routed in a particularly wear-protected manner. Further objects include the creation of a robot arm having at least one corresponding drive device, and/or a corresponding rotary feedthrough for at least one joint of a robot arm.

The object is achieved by a drive device for a joint of a robot arm, having:
a motor with a motor housing and a hollow motor shaft rotatably mounted in the motor housing,
a gearing, arranged coaxially with the motor shaft, having a hollow gearing input element coupled to the motor shaft, a hollow gearing output element, and a support element coupling the gearing input element to the gearing output element,
a cable guide tube, connected to the gearing output element, which extends axially from its gearing-side tube end from the gearing output element through the hollow motor shaft to its motor-side tube end of the motor housing axially opposite the gearing, and forms a guide tube end portion there,
a driver, connected to the guide tube end portion of the cable guide tube, which has a hub portion connected to the guide tube end portion, a radially outwardly offset cable guide portion, and a connecting portion connecting the hub portion to the cable guide portion,
an annular space, arranged coaxially with the motor, which is designed to accommodate a cable loop of a cable inserted into the annular space, wherein the annular space has an opening through which the cable can be fed into the annular space, wherein the cable guide portion of the driver is designed, when a cable is in the inserted state in which the cable is guided axially from the gearing-side tube end to the motor-side tube end through the cable guide tube, and guided radially to the cable guide portion, to entrain the cable in a transition portion of the cable into the opening of the annular space when the gearing output element is rotated, such that the cable is guided into the annular space at a circumferential point corresponding to the current rotational position of the gearing output element.

A drive device with a hollow motor shaft and a hollow gearing output element, making it possible to guide a cable through the hollow motor shaft and the hollow gearing output element, is particularly useful on robot arms. This allows the cable to be routed inside the robot arm, eliminating the need for external routing of the cable, which would be disadvantageous in terms of the robot arm's contours.

A cable can be a single cable or comprise multiple, separate lines, which may, for example, be bundled together. If a cable is to be routed through a hollow motor shaft, and especially in the case of a robot arm where the cable is to be routed from one link of the robot arm to an immediately adjacent link, a torsional load acting upon the cable can be detrimental and, in particular, shorten the service life of the cable, since excessive torsional stresses can lead to undesirable cable breaks.

However, certain torsional stresses are taken into account by cable manufacturers and are permitted to act upon the cable to a specified extent without causing harmful cable breaks within the predetermined service life of the cable. However, the manufacturers specify, among other things, minimum lengths to be observed for a cable portion, which also may be subjected only to a limited torsion angle.

However, especially in robot arms, the installation space is small and cables must be routed through hollow motor shafts to compensate for torsions that occur due to a relative rotational movement of two immediately adjacent links of a rotary joint of the robot arm. A limiting aspect is often that a hollow motor shaft cannot be full of cables across its entire cross-section; rather, a certain amount of free space must remain available so that the cable can deflect radially during torsional stress in order to reduce the torsional stresses. In this regard, cable manufacturers also specify a maximum degree of filling, which determines the ratio of the cross-section occupied by cables to the unoccupied cross-section in the hollow motor shaft.

Typically, gearings, especially those in robot arms, are designed with a reduction gear ratio, so that the motor shaft connected to the gearing input element rotates correspondingly faster than the hollow gearing output element.

In the drive device according to the invention, the cable guide tube is therefore connected to the hollow gearing output element, so that the cable guide tube also has the slower rotational speed. Since, particularly in the case of a robot arm, the gearing output element is connected to a link of the robot arm, the gearing output element does not perform any rotational movement relative to this link of the robot arm. For example, a cable attached to this link will therefore not perform any movement relative to this link of the robot arm.

In order to ensure that the cable is not subjected to any torsional stress along its length within the cable guide tube and, in particular, does not undergo any torsional movement, the cable guide tube is completely routed through the hollow motor shaft to an end of the drive device opposite the gearing output element, where the cable exits the cable guide tube and is then routed radially away. For this purpose, a driver is provided on the guide tube end portion of the cable guide tube, which guides the cable in the region of its radial portion and guides it on a cable guide portion of the driver in such a way that the cable in the region of its radial portion is rotated synchronously with the rotation of the gearing output element and thus synchronously with the cable guide tube, so that torsion of the cable is prevented, i.e., cannot occur, since the cable always follows the rotation of the gearing output element and the cable guide tube in the same way.

In the drive device according to the invention, the adaptation of the relative twist of one cable end with respect to the other cable end, or of the gearing output element with respect to the motor housing or a component connected to the motor housing, occurs in an annular space in which the cable at least largely does not undergo any torsion, but, rather, merely performs a bending movement or is subject to bending stress along a cable loop.

The annular space extends coaxially with the motor housing. Accordingly, a cable portion leading out of the annular space beyond the driver can be fixed to the motor housing or a component connected to the motor housing, in particular to a link of the robot arm connected to the motor housing and adjacent to the rotary joint.

The driver is fixed to the cable guide tube, so that the driver performs the same rotational movement as the cable guide tube and the gearing output element connected to the cable guide tube. Therefore, no wear-causing relative movement can occur between the cable and the annular space inner wall of the cable guide tube. This has the further advantage that the degree of filling of the cable guide tube can be increased, and thus a thicker cable or a cable bundle with a greater diameter can be guided through the hollow motor shaft than was previously possible.

The annular space can have an annular space inner wall surrounding the motor housing circumferentially and an annular space outer wall, arranged at a radial distance from the annular space inner wall, surrounding the annular space inner wall circumferentially, wherein a storage space for a cable loop of a cable guided through the annular space is formed between the annular space inner wall and the annular space outer wall, and the opening of the annular space lies on the same circumference as the cable guide portion of the driver.

The annular space inner wall supports a cable loop of an inserted cable running within the annular space from the radial inside. The annular space outer wall supports the cable loop of an inserted cable running within the annular space from the radial outside. The storage space is, in that respect, a circular cylindrical annular space. The annular space can have an opening at least on one of its two end faces through which the transition portion of the cable, guided by the driver, is directed into the annular space. The opening can accordingly be a circular, annular opening. The opening can extend coaxially around the motor housing. The opening can have a radial opening width that is only slightly greater than the diameter of the cable.

The annular space or storage space for the cable loop can thus form a cable barrel. This does not necessarily have to be at the same axial height as the motor of the drive device. The annular space can therefore also be arranged axially offset from the motor.

However, especially in drive device designs where the motor has a significantly smaller diameter compared to the gearing, and thus the gearing has a significantly greater diameter compared to the motor, it can be particularly advantageous if the annular space is arranged at the same axial height as the motor. In this respect, the annular space can surround the motor circumferentially. The annular space or the storage space for the cable loop can, in particular, have a radial height that is less than half the diameter difference between the diameter of the motor and the diameter of the gearing. Consequently, the annular space or the storage space for the cable loop can have an outer diameter that is at least slightly smaller than the outer diameter of the gearing. Thus, despite an additional annular space for the cable loop, a particularly compact design for the drive device can be achieved.

The connecting portion of the driver can be formed by a lever extending radially from the hub portion to the cable guide portion.

The driver does not necessarily have to be designed as a circular disk. The connecting portion can therefore also be rod-shaped and, in its basic form, functionally provides only a rigid connection between the hub portion and the cable guide portion, so that the rotational position of the hub portion is transferred to the rotational position of the cable guide portion with positional accuracy. However, the connecting portion can include additional functions besides acting as a lever connecting the hub portion to the cable guide portion.

The connecting portion of the driver can alternatively be formed by a circular disk or a circular disk segment extending radially from the hub portion to the cable guide portion, instead of a lever.

If the driver is designed as a circular disk, the circular disk covers the rear end face of the motor or the entire drive device, and can therefore also serve as a protective cap, which can, for example, keep out dust and prevent unwanted interference with the drive device. Furthermore, the annular space inner wall, facing the motor, of the circular disk can form a lateral guide surface for the cable loop present in the annular space. The circular disk largely covers the opening of the annular space, with the exception of the region of the cable guide portion.

Even in the case of a driver designed as a circular disk segment, the annular space inner wall, facing the motor, of the circular disk segment can form a lateral guide surface for the cable loop present in the annular space. The expansion angle of the circular disk segment can be adapted to the maximum rotation angle difference between the motor housing and the gearing output element.

The driver can in particular be designed in a cup shape, wherein the connecting portion designed as a circular disk is formed by a cup base surface of the cup-shaped driver, and at least one cup lateral surface of the cup-shaped driver axially forms at least partially or completely the annular space outer wall and/or the annular space inner wall.

In this modified embodiment, the driver thus also forms part of the annular space, i.e., part of the annular space outer wall and/or the annular space inner wall. The cup lateral surface of the cup-shaped driver can extend, in particular, over half the axial width of the annular space. Accordingly, the half, facing the driver, of the cable loop can be covered by a cup lateral surface or enclosed between two, coaxially spaced cup lateral surfaces of the cup-shaped driver. The annular space inner wall formed by an inner cup lateral surface must be mounted at least at a small distance from the motor housing. Thus, the annular space inner wall formed by the inner cup lateral surface can perform a movement relative to the motor housing. In this embodiment variant, the inner cup lateral surface is not part of the motor housing.

An inner wall, facing the annular space, of the connecting portion, designed as a circular disk or circular disk segment, of the driver can form an axial annular end wall of the annular space or a circumferential subportion of the axial annular end wall of the annular space, on which a cable loop formed in the annular space is guided axially.

The inner wall prevents the cable loop from exiting the annular space. Due to the bending stresses in the bending portion of the cable loop, there is a tendency for the limbs of the cable loop to be pushed axially outwards. Such pushing out is prevented by the annular space inner wall of the connecting portion of the driver.

The cable guide portion can have a radially oriented guide wall that leads in the direction of rotation of the driver and a radially oriented guide wall that lags in the direction of rotation of the driver, wherein the two guide walls are spaced apart from each other in such a way that an inserted cable is guided from two opposite sides.

The cable guide portion can thus be formed by an open-edged recess in the driver, in particular in a driver designed as a circular disk or as a circular disk segment. The recess can have an axial gap width that is adapted to the diameter of the cable to be guided. The axial gap width of the recess can therefore be slightly larger than the diameter of the cable to be guided. A certain amount of play between the recess and the inserted cable is harmless.

Depending upon the direction of rotation, one of the two guide walls serves as a driver edge to rotate the cable according to the rotation angle position of the gearing output element or the rotation angle position of the guide tube, i.e., to entrain it. The cable radial portion of the cable can optionally be fixed to the outer side wall of the driver.

The drive device can have a cable, inserted into the cable guide tube, which is attached to the gearing output element or to a component connected to the gearing output element, and which is led axially out of the cable guide tube at the motor-side tube end, and is guided in a radial direction to the cable guide portion, where it enters the annular space and forms a cable loop therein.

The drive device itself can also be a device without an inserted cable, which can be manufactured and offered, for example, as a spare part or supplier part. The drive device can also be designed as a kit, in which the drive device is already equipped with an inserted cable. In the case of multiple drive devices, e.g., those to be mounted in a robot arm, each of the multiple drive devices can have a cable portion that may be equipped with electrical plugs, sockets, or couplings at both cable ends. Each drive device can then be mounted together with its assigned cable portion, and, subsequently, the multiple cable portions can be electrically connected using their electrical plugs, sockets, or couplings. Alternatively, it can also be provided that a single cable or a single cable bundle be looped through multiple drive devices.

The object is also achieved by a robot arm having multiple links and joints connecting the links in a manner allowing relative movement, wherein at least one of the joints has a drive device according to any of the described embodiments.

The joint, which has the drive device according to any of the described embodiments, of the robot arm can have a hollow first link and a second link rotatably connected directly to the hollow first link. In the robot arm, the motor housing can be arranged inside the hollow first link, and a space can be formed between an outer surface of the motor housing and an inner surface of the hollow first link, in which the annular space is arranged.

A cable inserted into the cable guide tube can be fixed to the second link connected to the gearing output element.

The technical teaching according to the invention is not limited to drive devices, but can also be implemented in non-driven joints, viz., in the form of a rotary feedthrough which guides a cable, for example, over a hinge region. In such a hinge region, a first component or first link also rotates relative to a second component or second link. Analogous challenges arise there for avoiding torsion in the cable when it has to be guided in the axial direction through a hollow pin and a hollow pivot pin receptacle.

The object is accordingly also achieved by a rotary feedthrough for a joint of a robot arm, having:
a hollow pivot pin receptacle,
a hollow pivot pin rotatably mounted coaxially in the hollow pivot pin receptacle,
a cable guide tube, connected to the hollow pivot pin, which extends axially from a pin-base-side tube end through the hollow pivot pin to its pin-head-side tube end, axially opposite the pin base, of the hollow pivot pin receptacle, and forms a guide tube end portion there,
a driver, connected to the guide tube end portion of the cable guide tube, which has a hub portion connected to the guide tube end portion, a radially outwardly offset cable guide portion, and a connecting portion connecting the hub portion to the cable guide portion,
an annular space, arranged coaxially with the hollow pivot pin receptacle, which is designed to accommodate a cable loop of a cable inserted into the annular space, wherein the annular space has an opening through which the cable can be fed into the annular space, wherein the cable guide portion of the driver is designed, when a cable is in the inserted state in which the cable is guided axially from the pin-base-side tube end to the pin-head-side tube end through the cable guide tube, and guided radially to the cable guide portion, to entrain the cable in a transition portion of the cable into the opening of the annular space when the hollow pivot pin rotates relative to the hollow pivot pin receptacle, such that the cable is guided into the annular space at a circumferential point corresponding to the current rotational position of the hollow pivot pin relative to the hollow pivot pin receptacle.

The features described in connection with the drive device, in particular with regard to the cable guide tube, the driver and the annular space, are applicable in an analogous manner to the rotary feedthrough. Accordingly, the relevant disclosures regarding the drive device also apply to the rotary feedthrough.

Specific exemplary embodiments of the invention are explained in more detail in the following description with reference to the accompanying figures. Specific features of these exemplary embodiments, possibly considered individually or in further combinations, can represent advantageous features of alternative embodiment variants of the invention, regardless of the specific connection in which they are mentioned.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 depicts a perspectival view of a representative exemplary embodiment of a robot, in particular a lightweight robot, which can be designed for human/robot collaboration, comprising a robot arm with links, joints, and drive devices, and a control device designed and configured to automatically control the drive devices to move the robot arm,

FIG. 2 depicts a perspectival partial view of an exemplary modified robot arm in the region of a joint of the robot arm, which comprises a drive device,

FIG. 3 is a perspectival sectional view of an exemplary embodiment of a drive device according to the present disclosure,

FIG. 4 depicts an axial sectional view of the exemplary embodiment of the drive device according to the present disclosure as shown in FIG. 3, with a cup-shaped modified driver in a first embodiment variant with only one outer cup lateral surface,

FIG. 5 depicts an axial sectional view of the exemplary embodiment of the drive device according to the disclosure as shown in FIG. 3 with a cup-shaped modified driver in a second embodiment variant with an outer cup lateral surface and an inner cup lateral surface,

FIG. 6 depicts a perspectival view of the drive device according to FIG. 3 in an external view with an annular space outer wall of an annular space surrounding the motor, and a circular disk driver,

FIG. 7 depicts a perspectival view of the drive device according to FIG. 6 with the annular space outer wall removed, so that the cable loop stored in the annular space is visible,

FIG. 8 depicts a perspectival view of the drive device according to FIG. 6 with a first embodiment variant of a semicircular disk driver, modified compared to the circular disk driver, and

FIG. 9 depicts a perspectival view of the drive device according to FIG. 6 with a second embodiment variant of a driver as a lever, modified compared to the circular disk driver and the semicircular disk driver.

### DETAILED DESCRIPTION

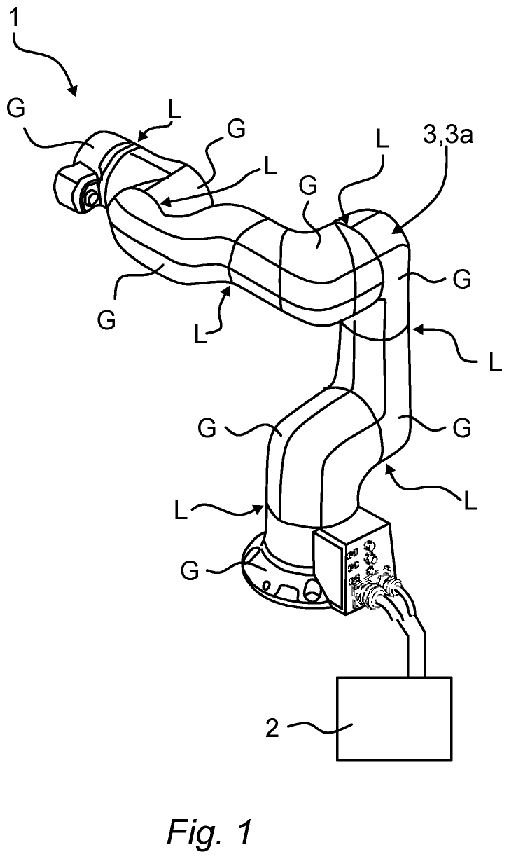

FIG. 1 shows a robot arm 3 having multiple links G and joints L connecting the links G in manner allowing relative movement, wherein at least one of the joints L can have a drive device 4 according to the principles of the present disclosure.

FIG. 1 shows the robot arm 3 in the form of a lightweight robot 3a with a total of six or seven axes. This lightweight robot 3a is particularly well suited for human/robot collaboration. The lightweight robot 3a can be operated in force/torque control mode using a control device 2, especially in compliance control mode. This lightweight robot 3a has multiple links G, and joints L that move the links G relative to each other. All joints L are designed as rotary joints. In this respect, each joint L connects a first link G1 of the robot arm 3 to an immediately adjacent second link G2 of the robot arm 3 in a rotatable manner, wherein the corresponding rotary joint can have a drive device 4 according to the invention in one of the described embodiments.

In the robot arm 3 with the multiple links G and multiple joints L, each joint L connects two immediately adjacent links G in the kinematic chain of the robot arm 3 in a manner allowing movement, by means of automatically controlled drive devices 4, each of which is designed to move one of the joints L, such that, by automatically controlled movement of the joints L by means of the respective drive devices 4, the links G of the robot arm 3 can be moved into a desired joint configuration.

At least one of the drive devices 4, in particular multiple or all drive devices 4 of the joints L, can be designed as a drive device 4 according to any of the described embodiments of the invention.

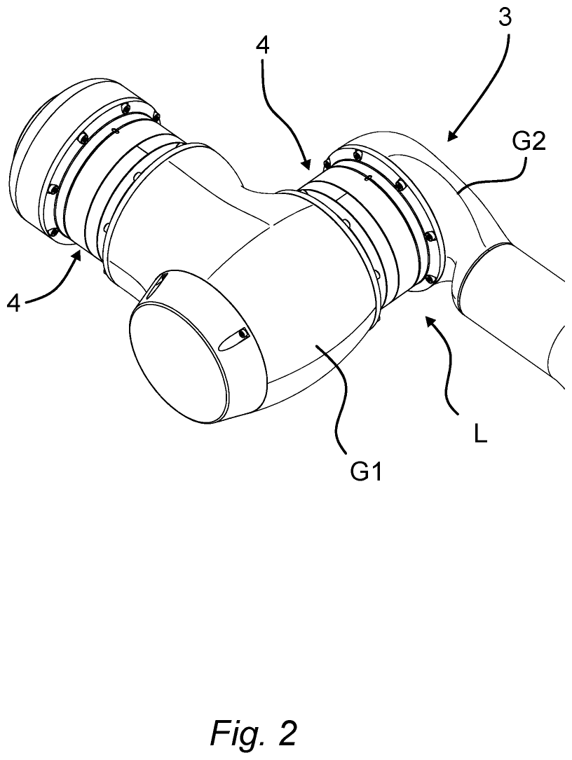

FIG. 2 shows a subregion of the robot arm 3, which has multiple links G and multiple joints L connecting the links G in a manner allowing relative movement, at least one of which joint L is designed as a rotary joint which has a drive device 4 according to any of the described embodiments.

Optionally, all joints of the robot arm 3 can each be equipped with a drive device 4 according to any of the described designs, or only a subset of the joints L can be equipped with a drive device 4 according to any of the described designs. In a simple embodiment, the robot arm 3 may optionally have only a single joint L, which is equipped with a drive device 4 according to any of the described embodiments, wherein the other joints L of the robot arm 3 may then be equipped with conventional drives.

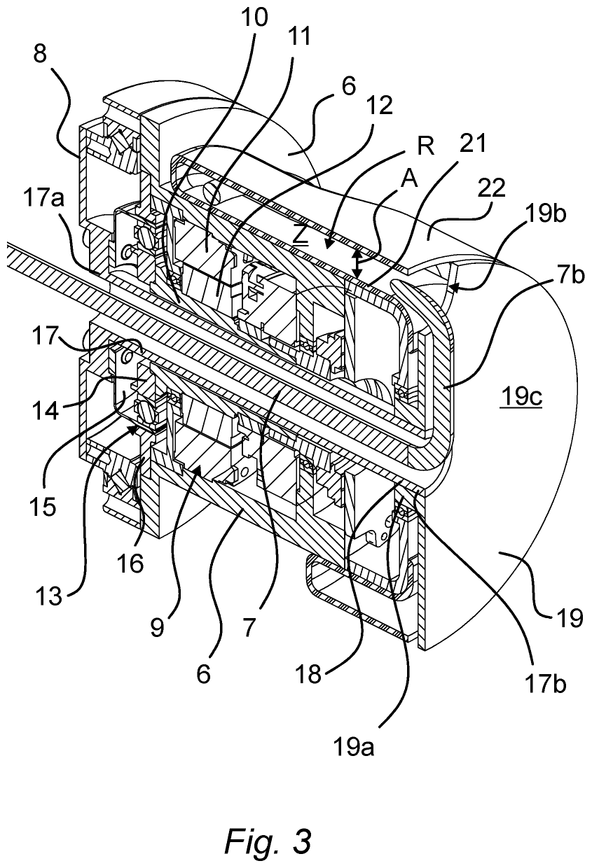

The joint L, having the drive device 4 according to any of the described embodiments, of the robot arm 3 can have a hollow first link G1 and a second link G2 rotatably connected directly to the hollow first link G1, wherein a motor housing 6 of the drive device 4 can be arranged at least partially or completely inside the hollow first link G1, and an intermediate space Z is formed, between an outer surface of the motor housing 6 and an inner surface of the hollow first link G1, in which the annular space R is arranged. This is shown, for example, in FIG. 3.

An inserted cable 7 can, for example, be fixed to the second link G2 connected to a gearing output element 15 of the drive device 4.

The drive device 4 according to the invention, shown in FIGS. 3 to 9 as an example, for one of the joints L of the robot arm 3, has a motor 9 with the motor housing 6 and a hollow motor shaft 10 rotatably mounted in the motor housing 6. The motor 9 can have a stator 11 connected to the motor housing 6 and a rotor 12 running therein. The rotor 12 is connected to the hollow motor shaft 10.

The drive device 4 also has a gearing 13, arranged coaxially with the motor shaft 10, which has a hollow gearing input element 14 coupled to the motor shaft 10, a hollow gearing output element 15, and a support element 16 coupling the gearing input element 14 to the gearing output element 15.

As can be seen in particular in FIG. 3, in the case of the present exemplary embodiments, the gearing 13 is designed as a strain wave gear.

In this strain wave gear, the wave generator forms the gearing input element 14 on the drive side, and the output bushing (flexspline) forms the gearing output element 15 on the drive side. The internally toothed outer ring (circular spline) of the strain wave gear forms the support element 16, which is connected to the motor housing 6.

The drive device 4 also comprises a cable guide tube 17, connected to the gearing output element 15, which extends axially from its gearing-side tube end 17a from the gearing output element 15 through the hollow motor shaft 10 to its motor-side tube end 17b of the motor housing 6 which is axially opposite the gearing 13, and forms a guide tube end portion 18 there.

The drive device 4 has a driver 19, connected to the guide tube end portion 18 of the cable guide tube 17, which has a hub portion 19a connected to the guide tube end portion 18, a cable guide portion 19b offset radially outwards, and a connecting portion 19c connecting the hub portion 19a to the cable guide portion 19b.

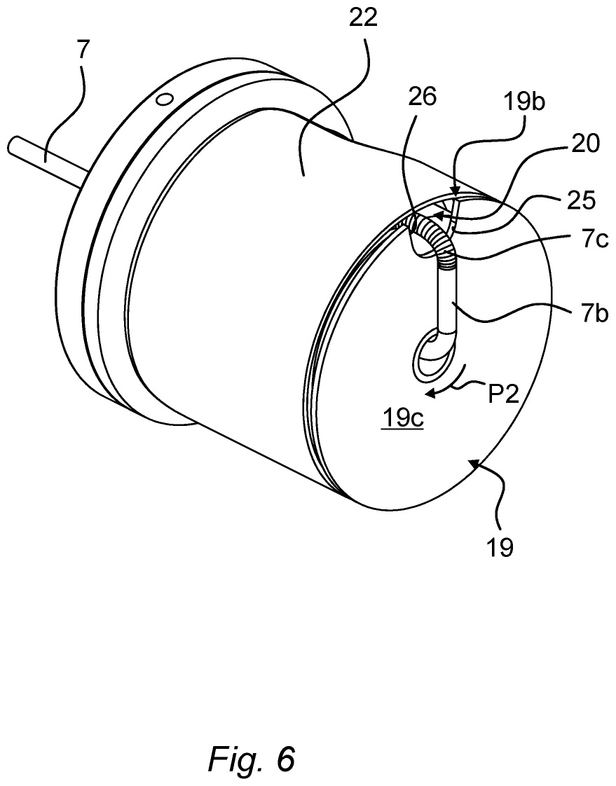

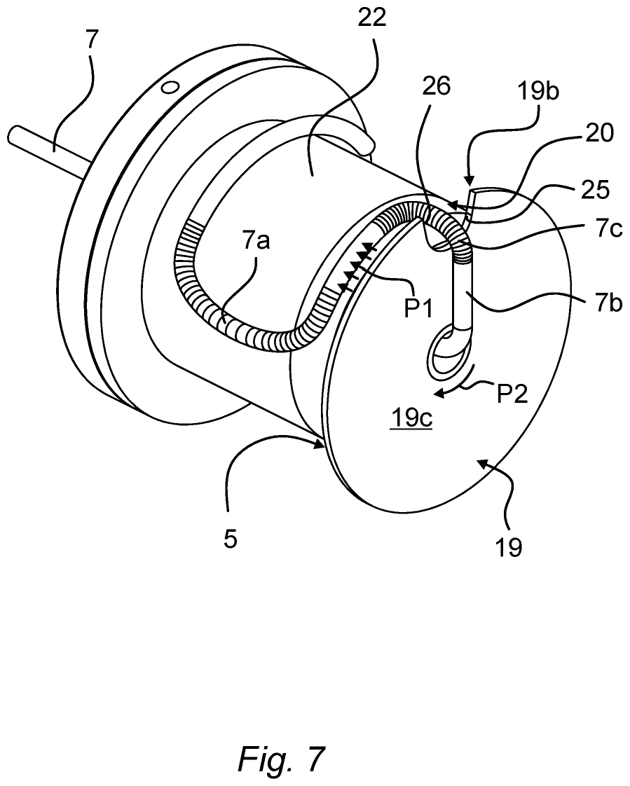

The drive device 4 also has an annular space R, arranged coaxially with the motor 9, which is designed to accommodate a cable loop 7a of a cable 7 inserted into the annular space R, as is shown in particular in FIG. 7. The annular space R has an opening 20 (FIG. 6) through which the cable 7 can be fed into the annular space R, wherein the cable guide portion 19b of the driver 19 is designed, in an inserted state of the cable 7 in which the cable 7 is guided axially from the gearing-side tube end 17a to the motor-side tube end 17b through the cable guide tube 17 and radially via a cable radial portion 7b to the cable guide portion 19b, to entrain the cable 7 in a transition portion 7c of the cable 7 into the opening 20 of the annular space R when the gearing output element 15 is rotated, such that the cable 7 is guided into the annular space R at a circumferential point corresponding to the current rotational position of the gearing output element 15.

The annular space R has an annular space inner wall 21 circumferentially surrounding the motor housing 6 and an annular space outer wall 22, arranged at a radial distance A from the annular space inner wall 21, circumferentially surrounding the annular space inner wall 21, wherein a storage space for the cable loop 7a of the cable 7 guided through the annular space R is formed between the annular space inner wall 21 and the annular space outer wall 22, and the opening 20 of the annular space R lies on the same circumference as the cable guide portion 19b of the driver 19.

The connecting portion 19c of the driver 19 can be formed by a circular disk extending radially from the hub portion 19a to the cable guide portion 19b, according to a basic embodiment as shown in FIG. 6 and FIG. 7.

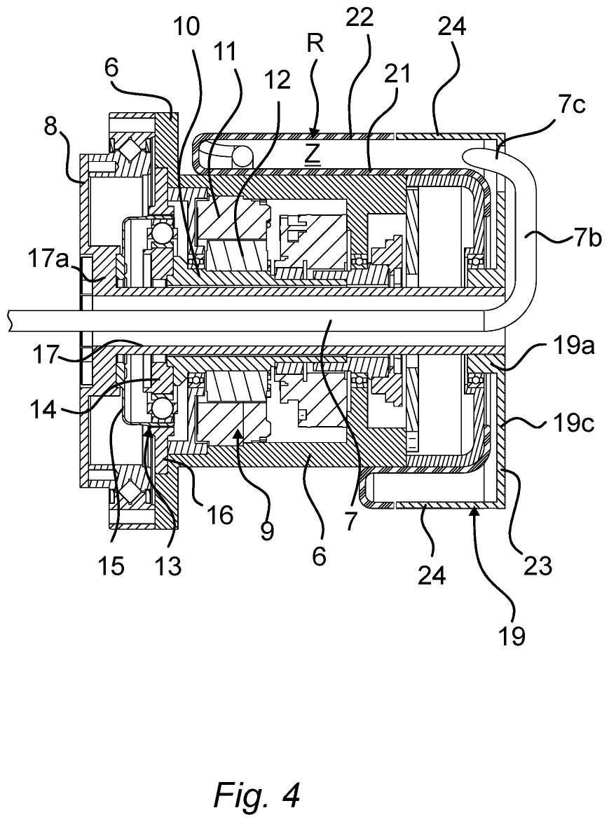

The driver 19 can alternatively also be designed in a cup shape, as is shown, for example, in the sectional view of FIG. 4, wherein the connecting portion 19c designed as a circular disk is formed by a cup base surface 23 of the cup-shaped driver 19, and a cup lateral surface 24 of the cup-shaped driver 19 forms at least partially axially, or completely, the annular space outer wall 22 of the annular space R.

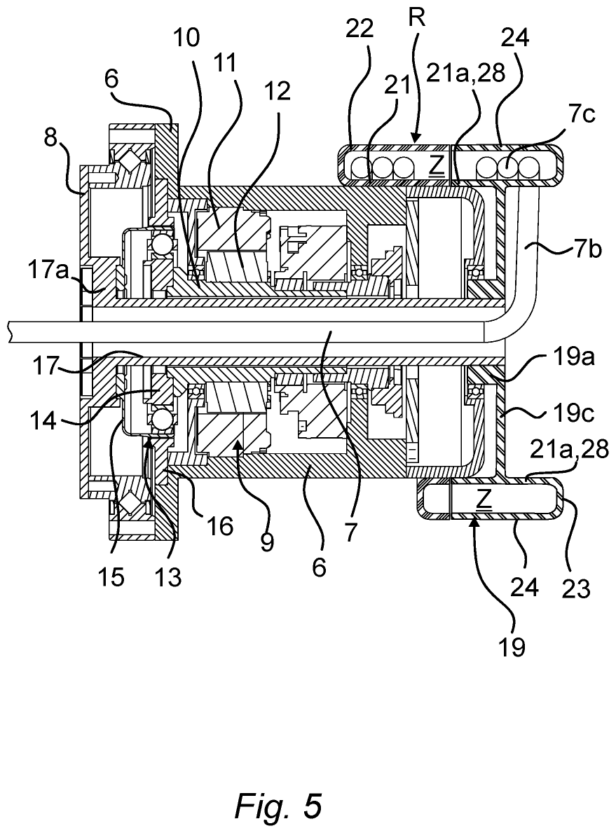

The cup-shaped driver 19 can, in a further variant, as shown for example in the sectional view of FIG. 5, have two cup lateral surfaces, viz., an outer cup lateral surface 24 and an inner cup lateral surface 28.

Accordingly, the half, facing the driver 19, of the cable loop 7a can be enclosed between two, coaxially spaced cup lateral surfaces 24 and 28 of the cup-shaped driver 19. The annular space inner wall 21a formed by an inner cup lateral surface 28 is mounted at least at a slight distance from the motor housing 6. Thus, the annular space inner wall 21a formed by the inner cup lateral surface 28 can perform a relative movement to the motor housing 6. In this embodiment variant according to FIG. 5, the inner cup lateral surface 28 is then not part of the motor housing 6. In this variant according to FIG. 5, the annular space R does not completely surround the motor housing 6, but is partially axially offset beyond the rear end face of the motor housing 6. Alternatively, the cable loop 7c does not enter the annular space R axially at the end face, but, rather, radially from below through the inner cup lateral surface 28.

FIG. 7 shows how an inner wall 5 of the connecting portion 19c of the driver 19, which is designed as a circular disk and faces the annular space R, can form an axial annular end wall of the annular space R, on which a cable loop 7a of the cable 7 formed in the annular space R can be guided axially, i.e., in the direction of arrow P1.

The cable guide portion 19b has a radially oriented guide wall 25, leading in the direction of rotation P2 of the driver 19, and a radially oriented guide wall 26 lagging in the direction of rotation P2 of the driver 19, wherein the two guide walls 25, 26 are arranged spaced apart from each other such that an inserted cable 7 is guided from two opposite sides.

FIGS. 3 to 9 show the drive device 4 with a cable 7, inserted into the cable guide tube 17, which is attached to the gearing output element 15 or to a component 8 connected to the gearing output element 15, wherein the cable 7 is led axially out of the cable guide tube 17 at the motor-side tube end 17b and is guided radially as the cable radial portion 7b to the cable guide portion 19b, where it enters the annular space R in its transition portion 7c and forms the cable loop 7a therein, as is particularly clearly shown in FIG. 7.

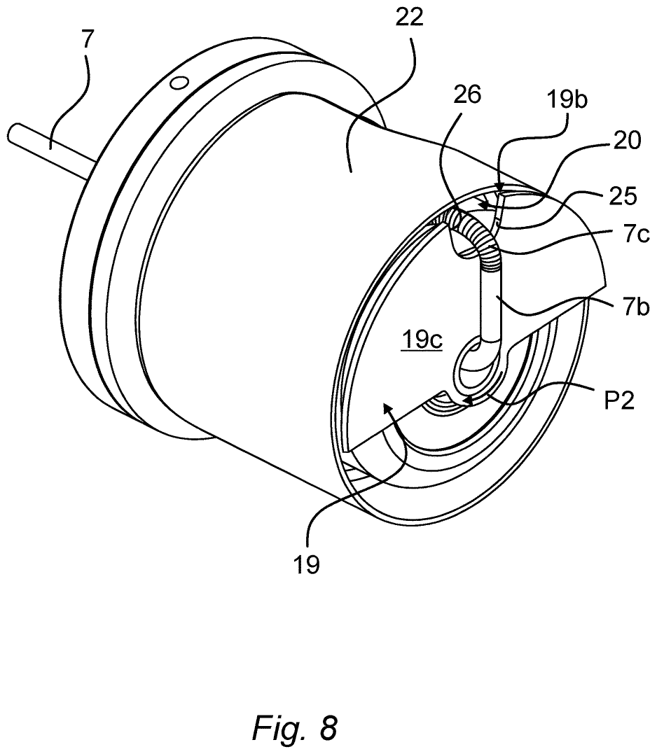

FIG. 8 shows a perspectival view of the drive device 4 according to FIG. 6 with a first embodiment variant of a semicircular disk driver 19, modified compared to the circular disk driver 19. In this first embodiment variant, the connecting portion 19c of the driver 19 is formed by a circular disk segment extending radially from the hub portion 19a to the cable guide portion 19b with a segment angle of, for example, 180 degrees. However, other segment angles, such as 90 degrees or 270 degrees, or other intermediate angle values are also conceivable and possible.

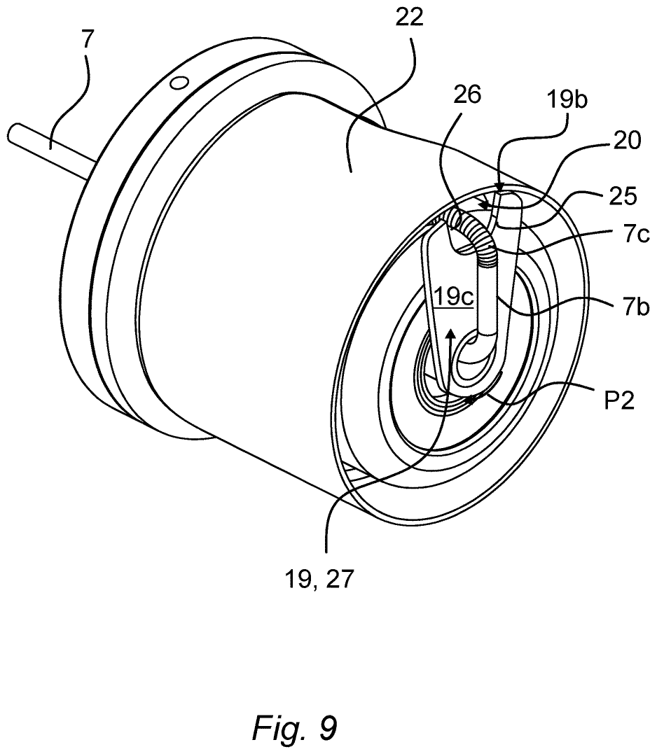

FIG. 9 shows a perspectival view of the drive device according to FIG. 6 with a second embodiment variant of a driver 19 as a lever 27, which is modified compared to the circular disk and the semicircular disk driver 19.

In this second embodiment variant, the connecting portion 19c of the driver 19 is formed by a lever 27 extending radially from the hub portion 19a to the cable guide portion 19b.

While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be

1. Drive device (4) for a joint (L) of a robot arm (3), having:
a motor (9) having a motor housing (6) and a hollow motor shaft (10) rotatably mounted in the motor housing (6),
a gearing (13), arranged coaxially with the motor shaft (10), having a hollow gearing input element (14) coupled to the motor shaft (10), a hollow gearing output element (15), and a support element (16) coupling the gearing input element (14) to the gearing output element (15),
a cable guide tube (17), connected to the gearing output element (15), which extends axially from its gearing-side tube end (17a) from the gearing output element (15) through the hollow motor shaft (10) to its motor-side tube end (17b) of the motor housing (6) which is axially opposite the gearing (13), and forms a guide tube end portion (18) there,
a driver (19), connected to the guide tube end portion (18) of the cable guide tube (17), which has a hub portion (19a) connected to the guide tube end portion (18), a cable guide portion (19b) offset radially outwards, and a connecting portion (19c) connecting the hub portion (19a) to the cable guide portion (19b),
an annular space (R), arranged coaxially with the motor (9), which is designed to accommodate a cable loop (7a) of a cable (7) inserted into the annular space (R), wherein the annular space (R) has an opening (20) through which the cable (7) can be fed into the annular space (R), wherein the cable guide portion (19b) of the driver (19) is designed, in an inserted state of the cable (7) in which the cable (7) is guided axially from the gearing-side tube end (17a) to the motor-side tube end (17b) through the cable guide tube (17) and is guided radially to the cable guide portion (19b), to entrain the cable (7) into the opening (20) of the annular space (R) in a transition portion (7c) of the cable (7) when the gearing output element (15) is rotated, such that the cable (7) is guided into the annular space (R) at a circumferential point corresponding to the current rotational position of the gearing output element (15).

2. Drive device (4) according to claim 1, characterized in that the annular space (R) has an annular space inner wall (21) circumferentially enclosing the motor housing (6) and an annular space outer wall (22), arranged at a radial distance (A) from the annular space inner wall (21), circumferentially surrounding the annular space inner wall (21), wherein a storage space for a cable loop (7a) of a cable (7) guided through the annular space (R) is formed between the annular space inner wall (21) and the annular space outer wall (22), and the opening (20) of the annular space (R) lies on the same circumference as the cable guide portion (19b) of the driver (19).

3. Drive device (4) according to claim 1, characterized in that the connecting portion (19c) of the driver (19) is formed by a lever (27) extending radially from the hub portion (19a) to the cable guide portion (19b).

4. Drive device (4) according to claim 1, characterized in that the connecting portion (19c) of the driver (19) is formed by a circular disk or a circular disk segment extending radially from the hub portion (19a) to the cable guide portion (19b).

5. Drive device (4) according to claim 4, characterized in that the driver (19) is cup-shaped, wherein the connecting portion (19c) designed as a circular disk is formed by a cup base surface (23) of the cup-shaped driver (19), and at least one cup lateral surface (24) of the cup-shaped driver (19) axially forms at least partially or completely the annular space outer wall (22) of the annular space and/or the annular space inner wall (21) of the annular space (R).

6. Drive device (4) according to claim 4, characterized in that an inner wall (5), facing the annular space (R), of the connecting portion (19c), designed as a circular disk, of the driver (19) forms an axial annular end wall of the annular space (R), on which a cable loop (7c) formed in the annular space (R) is axially guided.

7. Drive device (4) according to claim 1, characterized in that the cable guide portion (19b) has a radially oriented guide wall (25), leading in the direction of rotation (P2) of the driver (19), and a radially oriented guide wall (26) lagging in the direction of rotation (P2) of the driver (19), wherein the two guide walls (25, 26) are arranged spaced apart from each other such that an inserted cable (7) is guided from two opposite sides.

8. Drive device (4) according to claim 1, having a cable (7), inserted into the cable guide tube (17), which is attached to the gearing output element (15) or to a component (8) connected to the gearing output element (15), and which is guided axially out of the cable guide tube (17) at the motor-side tube end (17b), and is guided in a radial direction to the cable guide portion (19b), where it enters the annular space (R) and forms a cable loop (7c) therein.

9. Robot arm (3) having multiple links (G) and joints (L) connecting the links (G) in a manner allowing relative movement, wherein at least one of the joints (L) has a drive device (4) according to claim 1.

10. Robot arm (3) according to claim 9, characterized in that the joint (L), having the drive device (4), of the robot arm (3) has a hollow first link (G1) and a second link (G2) rotatably connected directly to the hollow first link (G1), wherein the motor housing (6) is arranged inside the hollow first element (G1) and an intermediate space is formed, between an outer surface of the motor housing (6) and an inner surface of the hollow first element (G1), in which the annular space (R) is arranged.

11. Robot arm (3) according to claim 10, characterized in that a cable (7) inserted into the cable guide tube (17) is fixed to the second link (G2) connected to the gearing output element (15).

12. Rotary feedthrough for a joint (L) of a robot arm (3), having:
a hollow pivot pin receptacle,
a hollow pivot pin rotatably mounted coaxially in the hollow pivot pin receptacle,
a cable guide tube (17), connected to the hollow pivot pin, which extends axially from a pin-base-side tube end through the hollow pivot pin to its pin-head-side tube end, axially opposite the pin base, of the hollow pivot pin receptacle, and forms a guide tube end portion (18) there,
a driver (19), connected to the guide tube end portion (18) of the cable guide tube (17), which has a hub portion (19a) connected to the guide tube end portion (18), a cable guide portion (19b) offset radially outwards, and a connecting portion (19c) connecting the hub portion (19a) to the cable guide portion (19b),
an annular space (R), arranged coaxially with the hollow pivot pin receptacle, which is designed to accommodate a cable loop (7c) of a cable (7) inserted into the annular space (R), wherein the annular space (R) has an opening (20) through which the cable (7) can be fed into the annular space (R), wherein the cable guide portion (19b) of the driver (19) is designed, in an inserted state of a cable (7), in which the cable (7) is guided axially from the pin-base-side tube end to the pin-head-side tube end through the cable guide tube (17) and guided radially to the cable guide portion (19b), to entrain the cable (7) into the opening (20) of the annular space (R) during a rotation of the hollow pivot relative to the hollow pivot pin receptacle in a transition portion (7c) of the cable (7), such that the cable (7) is guided into the annular space (R) at a circumferential point corresponding to the current rotational position of the hollow pivot pin relative to the hollow pivot pin receptacle.
